(19) United States
(12) Patent Application Publication
(10) Pub. No.: US 2013/0293534 A1
(43) Pub. Date: Nov. 7, 2013

(54) DISPLAY UNIT AND ELECTRONIC APPARATUS

(71) Applicant: SONY CORPORATION, Tokyo (JP)

(72) Inventors: Yoshihisa Sato, Saitama (JP); Chiaki Kanai, Kanagawa (JP)

(73) Assignee: Sony Corporation, Tokyo (JP)

(21) Appl. No.: 13/870,635

(22) Filed: Apr. 25, 2013

(30) Foreign Application Priority Data
May 2, 2012 (JP) 2012-105218

(51) Int. Cl. G06T 15/00

(52) U.S. Cl. CPC G06T 15/00
USPC 345/419

(57) ABSTRACT

A display unit includes: a display section having a predetermined display region including a first region and a second region; and a control section allowing the display section to display a three-dimensional image in the first region and allowing the display section to display a two-dimensional image in the second region, the control section allowing the display section to time-divisionally display the three-dimensional image and the two-dimensional image.

### BACKGROUND

The present disclosure relates to a display unit that performs three-dimensional display (stereoscopic display) and to an electronic apparatus that includes such a display unit.

Methods performing three-dimensional display include an eyeglasses scheme that uses eyeglasses for stereoscopic vision and a naked-eye scheme that achieves stereoscopic vision with naked eyes without using the special eyeglasses for stereoscopic vision. Typical schemes of the naked-eye scheme are a parallax barrier scheme and a lenticular lens scheme. In the parallax barrier scheme and the lenticular lens scheme, a plurality of perspective images (perspective images for respective right and left eyes, in a case of two perspectives) for stereoscopic vision are displayed space-divisionally on a two-dimensional display panel, and the displayed perspective images are separated in a horizontal direction by a parallax device. Thus, stereoscopic vision is achieved. In the parallax barrier scheme, a parallax barrier that includes slit-like opening sections is used as the parallax device. In the lenticular lens scheme, a lenticular lens that includes a plurality of cylindrical lens elements arranged side-by-side is used as the parallax device.

In a display unit that uses a parallax device, spatial resolution is degraded since a plurality of perspective images are displayed space-divisionally. Japanese Unexamined Patent Application Publication No. 2009-104105 discloses a method of improving degradation in spatial resolution upon three-dimensional display by time-divisionally switching positions of opening sections of a parallax barrier and display positions of the plurality of perspective images.

### SUMMARY

In the display unit that uses the parallax device, it may become desirable that three-dimensional display be performed only in a partial region of a screen in some cases. In these cases, mixed display of a two-dimensional image and a three-dimensional image through the parallax device is achieved by displaying the same two-dimensional image in other regions instead of the plurality of perspective images. However, spatial resolution of both the two-dimensional image and the three-dimensional image is degraded.

It is desirable to provide a display unit and an electronic apparatus that are capable of mixed display of a two-dimensional image and a three-dimensional image without degrading spatial resolution of the two-dimensional image.

According to an embodiment of the present disclosure, there is provided a display unit including: a display section having a predetermined display region including a first region and a second region; and a control section allowing the display section to display a three-dimensional image in the first region and allowing the display section to display a two-dimensional image in the second region, the control section allowing the display section to time-divisionally display the three-dimensional image and the two-dimensional image.

According to an embodiment of the present disclosure, there is provided an electronic apparatus provided with a display unit, the display unit including: a display section having a predetermined display region including a first region and a second region; and a control section allowing the display section to display a three-dimensional image in the first region and allowing the display section to display a two-dimensional image in the second region, the control section allowing the display section to time-divisionally display the three-dimensional image and the two-dimensional image.

In the display unit and the electronic apparatus according to the embodiments of the present disclosure, the three-dimensional image is displayed in the first region in the predetermined display region and the two-dimensional image is displayed in the second region in the predetermined display region. Also, the three-dimensional image and the two-dimensional image are displayed time-divisionally.

According to the display unit and the electronic apparatus according to the embodiments of the present disclosure, the three-dimensional image and the two-dimensional image are displayed time-divisionally. Also, the three-dimensional image is displayed in the first region and the two-dimensional image is displayed in the second region. Therefore, mixed display of the two-dimensional image and the three-dimensional image is achieved. In particular, degradation in spatial resolution of the two-dimensional image is prevented since the display is performed time-divisionally.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a block diagram illustrating a configuration example of a display unit according to a first embodiment of the present disclosure.

FIG. 2 is a configuration diagram illustrating an example of a display unit of a lenticular lens scheme.

FIG. 3 is a configuration diagram illustrating an example of a display unit of a parallax barrier scheme.

FIG. 4 is a cross-sectional view illustrating a configuration example of a variable parallax device.

FIG. 5 is a plan view illustrating an example of an electrode structure in the parallax device shown in FIG. 4.

FIG. 6 is a cross-sectional view of the parallax device shown in FIG. 4 as seen from another direction.

FIG. 7 is a cross-sectional view illustrating an example of a state of the parallax device shown in FIG. 4 with voltage application.

FIG. 8 is a cross-sectional view illustrating an example of a state in which three-dimensional display is performed with the use of the parallax device shown in FIG. 4.

FIG. 9 is a cross-sectional view illustrating an example of a display unit of a parallax barrier scheme that is optically equivalent to a display unit shown in FIG. 8.

FIG. 10 is an explanatory diagram illustrating, in an upper part thereof, a state of performing three-dimensional display and illustrating, in a lower part thereof, a state of performing two-dimensional display.

FIG. 11 is a timing chart illustrating operation timing of each section in the display unit according to the first embodiment.

FIG. 12 is an explanatory diagram illustrating a display example of a three-dimensional image, a display example of a two-dimensional image, and a state in which a three-dimensional image and a two-dimensional image are displayed in a mixed manner.

FIG. 13 is an explanatory diagram illustrating display examples of images in a display unit according to a second embodiment.

FIG. 14 is a cross-sectional view illustrating an example of a display unit of a parallax barrier scheme that is optically equivalent to a display unit according to a third embodiment.

FIG. 15 is a timing chart illustrating operation timing of each section in the display unit according to a fourth embodiment.

FIG. 16 is a block diagram illustrating a configuration example of a display unit according to a fifth embodiment.

FIG. 17 is a cross-sectional view illustrating an example of a state of the display unit according to the fifth embodiment performing three-dimensional display.

FIG. 18 is a cross-sectional view illustrating an example of a display unit of a parallax barrier scheme that is optically equivalent to the display unit shown in FIG. 17.

FIG. 19 is a timing chart illustrating operation timing of each section in the display unit according to the fifth embodiment.

FIG. 20 is a cross-sectional view illustrating a configuration example of a display unit according to a sixth embodiment together with an emission state of light rays upon performing three-dimensional display.

FIG. 21 is a cross-sectional view illustrating a configuration example of the display unit according to the sixth embodiment together with an emission state of light rays upon performing two-dimensional display.

FIG. 22 is a block diagram illustrating a configuration example of the display unit according to the sixth embodiment.

FIG. 23 is a timing chart illustrating operation timing of each section in the display unit according to the sixth embodiment.

FIG. 24 is an appearance diagram illustrating an example of an electronic apparatus.

### DETAILED DESCRIPTION

Preferred embodiments of the present disclosure will be described below in detail with reference to the drawings. The description will be given in the following order.

### 1. First Embodiment

An example of a display unit of a backlight scheme

### 2. Second Embodiment

An example in which a part of a second region is included in a first region

### 3. Third Embodiment

An example in which a parallax device is arranged between a display section and a backlight

### 4. Fourth Embodiment

An example in which luminance of the backlight is varied between three-dimensional display and two-dimensional display

### 5. Fifth Embodiment

An example of a display unit using a self-emitting element

### 6. Sixth Embodiment

An example of a display unit using a light guide plate

### 7. Other Embodiments

A configuration example of an electronic apparatus, etc.

### 1. First Embodiment

### General Configuration of Display Unit

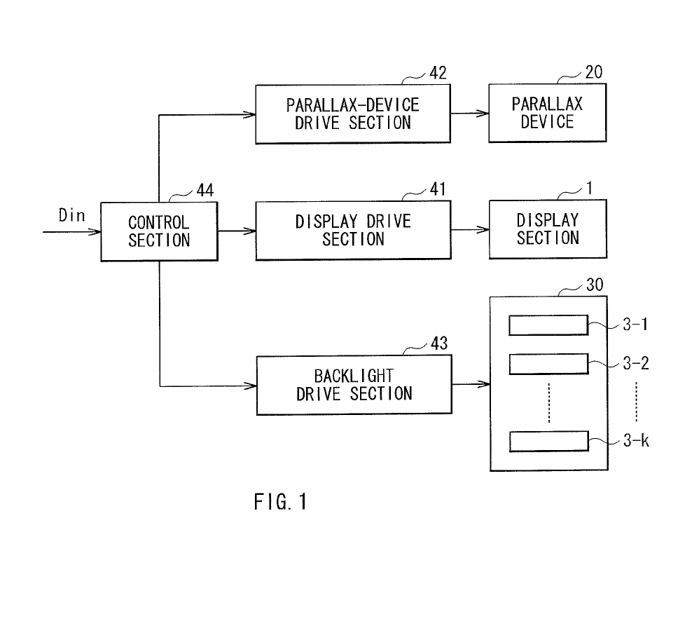

FIG. 1 illustrates a configuration example of a display unit according to a first embodiment of the present disclosure. The display unit includes a display section 1, a parallax device 20, a backlight 30, a display drive section 41, a parallax-device drive section 42, a backlight drive section 43, and a control section 44.

The backlight 30 emits light for image display toward the display section 1. The backlight 30 includes a plurality of partial light emission section 3-k (k is an integer of 2 or larger). Light emission of the backlight 30 is controlled partially and separately in a vertical direction. The partial light emission section 3-k may be configured, for example, of an LED (Light Emitting Diode). The backlight 30 is driven by the backlight drive section 43 based on control by the control section 44.

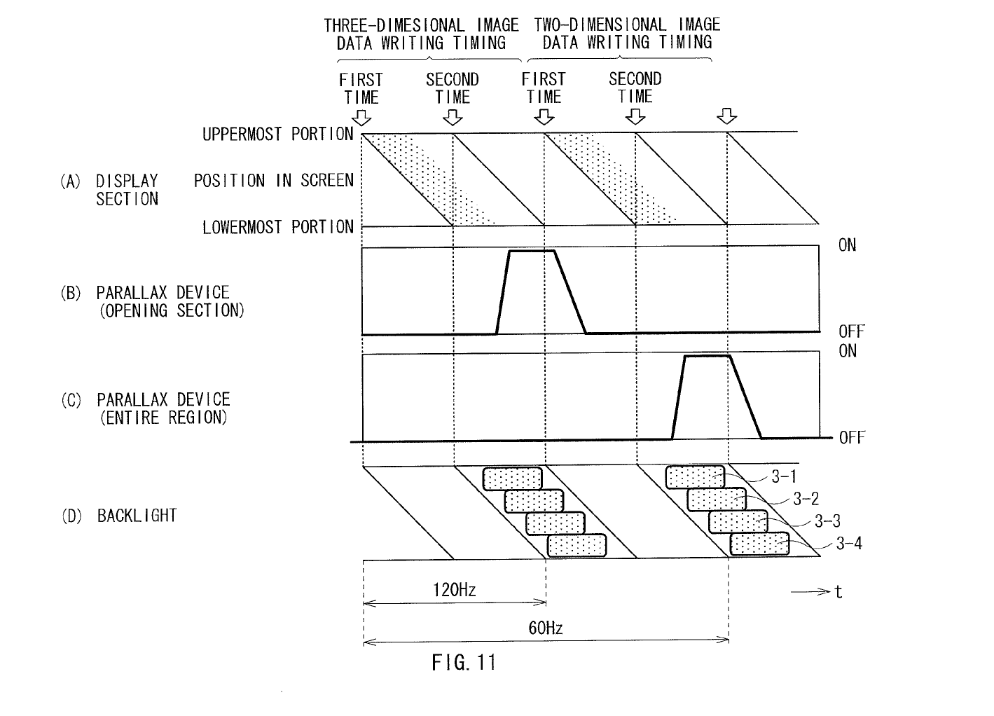

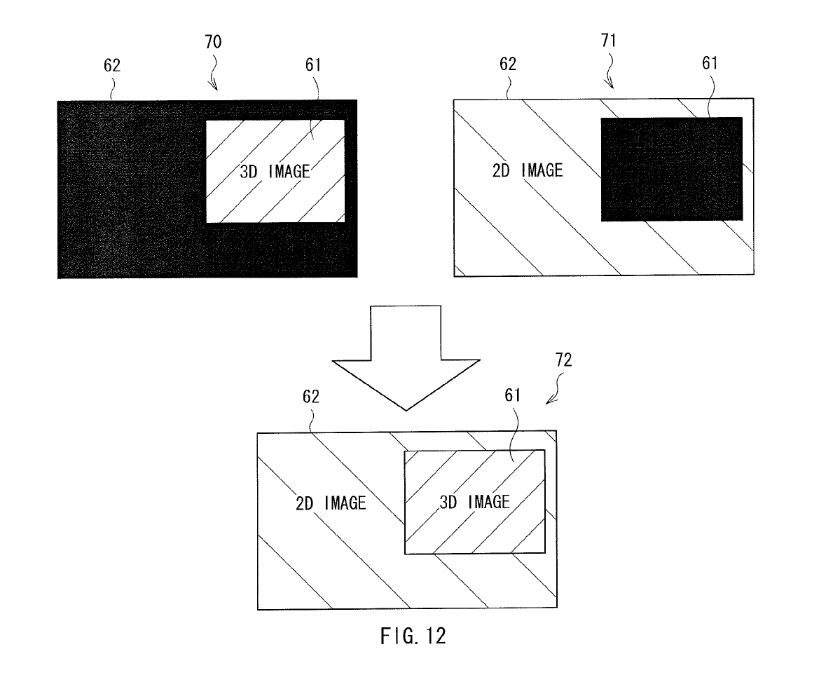

The display unit receives data that shows a two-dimensional image or a three-dimensional image as image data Din. The three-dimensional image is image data that includes parallax images (perspective images) for a plurality of perspectives. The display unit performs two-dimensional display upon receiving the data showing the two-dimensional image as the image data Din, and performs three-dimensional display upon receiving the data showing the three-dimensional image. The display unit is capable of switching display between three-dimensional display on an entire screen and two-dimensional display on the entire screen. In addition thereto, the display unit is capable of performing partial three-dimensional display (mixed display of a two-dimensional image and a three-dimensional display) as shown in FIG. 12 which will be described later by performing time-divisional operation control as shown in FIG. 11 which will be described later.

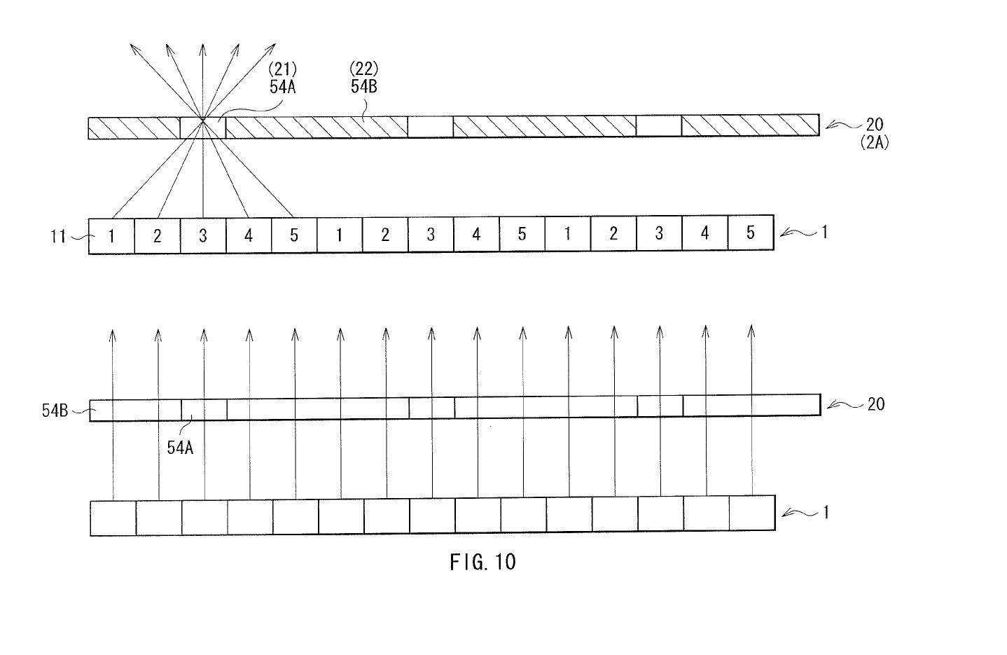

The display section 1 may be configured of a display for two-dimensional display of a backlight scheme, for example, a liquid crystal display panel. A plurality of pixels 11 are two-dimensionally arranged in a display screen of the display section 1 as shown in FIG. 10, etc. which will be described later. The display drive section 41 line-sequentially writes the inputted image data Din to the display section 1 based on the control by the control section 44, and thereby, the display section 1 displays an image. The display section 1 displays a parallax composite image in which the plurality of perspective images are synthesized upon performing three-dimensional display. The plurality of perspective images are displayed space-divisionally in a display region for three-dimensional display upon three-dimensional display.

The three-dimensional display scheme of the display unit is a naked-eye scheme that uses the parallax device 20. The parallax device 20 has a function that allows the respective plurality of perspective images displayed on the display section 1 to be separated in different directions. The parallax device 20 is a variable device in which the parallax function thereof is controlled to be activated or deactivated.

### [Configuration Example of Parallax Device 20]

Typical naked-eye schemes include a scheme such as a lenticular lens scheme and a parallax barrier scheme. First, the principles of the lenticular lens scheme and the parallax barrier scheme will be briefly described.

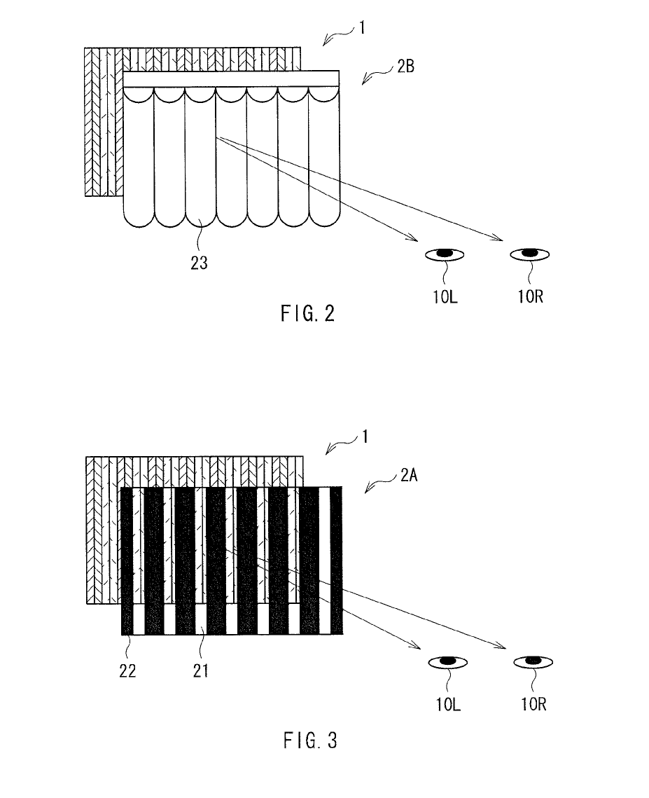

The lenticular lens scheme uses, for example, a lenticular lens 2B that may include, for example, a plurality of cylindrical lens elements 23 arranged side-by-side, for example, as shown in FIG. 2. The lenticular lens 2B spatially separates the plurality of perspective images displayed on the display section 1 and emits the separated perspective images toward a viewer. Thus, the respective plurality of perspective images displayed on the display section 1 are separated in different directions and different perspective images reach the respective left eye 10L and right eye 10R. Thus, stereoscopic vision is achieved. Configuring the lenticular lens 2B as a variable lens allows the lenticular lens 2B to be utilized as the variable parallax device 20. For example, a lens in which activation and deactivation of a lens effect is electrically controlled, such as a liquid crystal lens, may be used as the variable parallax device 20. In this case, the parallax-device drive section 42 electrically controls activation and deactivation of the lens effect based on the control by the control section 44. Switching between two-dimensional display and three-dimensional display is achieved by controlling switching of image data to be displayed on the display section 1 and by controlling switching of activation and deactivation of the lens effect of the parallax device 20.

The parallax barrier scheme uses a parallax barrier 2A, for example, as shown in FIG. 3. The parallax barrier 2A includes an opening section 21 that transmits light and a shielding section 22 that shields light. The parallax barrier 2A spatially separates the plurality of perspective images displayed on the display section 1 and emits the separated perspective images toward a viewer. Thus, the respective plurality of perspective images displayed on the display section 1 are separated in different directions and different perspective images reach the respective left eye 10L and right eye 10R. Thus, stereoscopic vision is achieved. Configuring the parallax barrier 2A as a variable barrier allows the parallax barrier 2A to be utilized as the variable parallax device 20. For example, a display function (optical modulation function) of a liquid crystal display device of a backlight scheme may be used to selectively form a pattern of the opening section 21 and the shielding section 22. In this case, the parallax-device drive section 42 electrically controls the pattern of the parallax barrier 2A, and thereby, switching between two-dimensional display and three-dimensional display is achieved in a manner similar to that in the above-described case using a variable lens as the lenticular lens 2B.

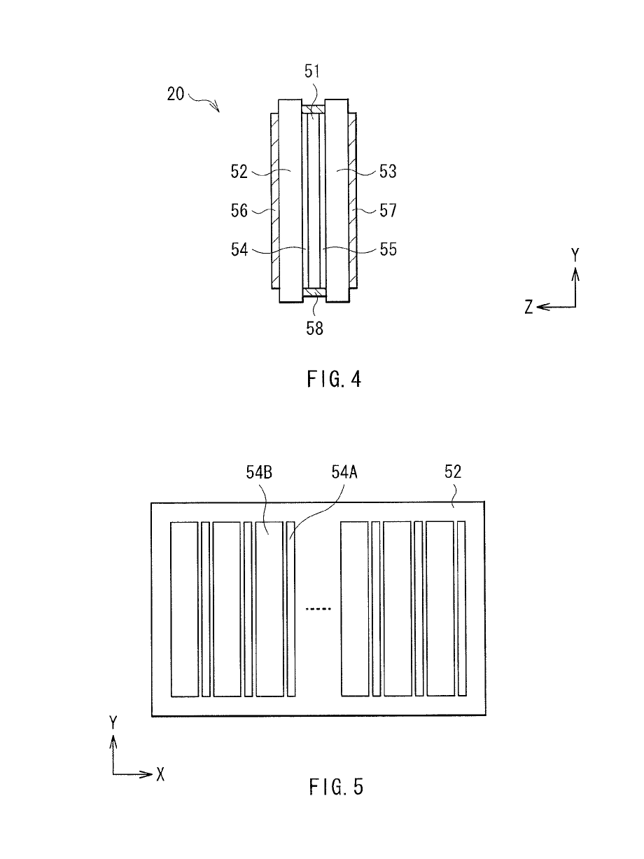

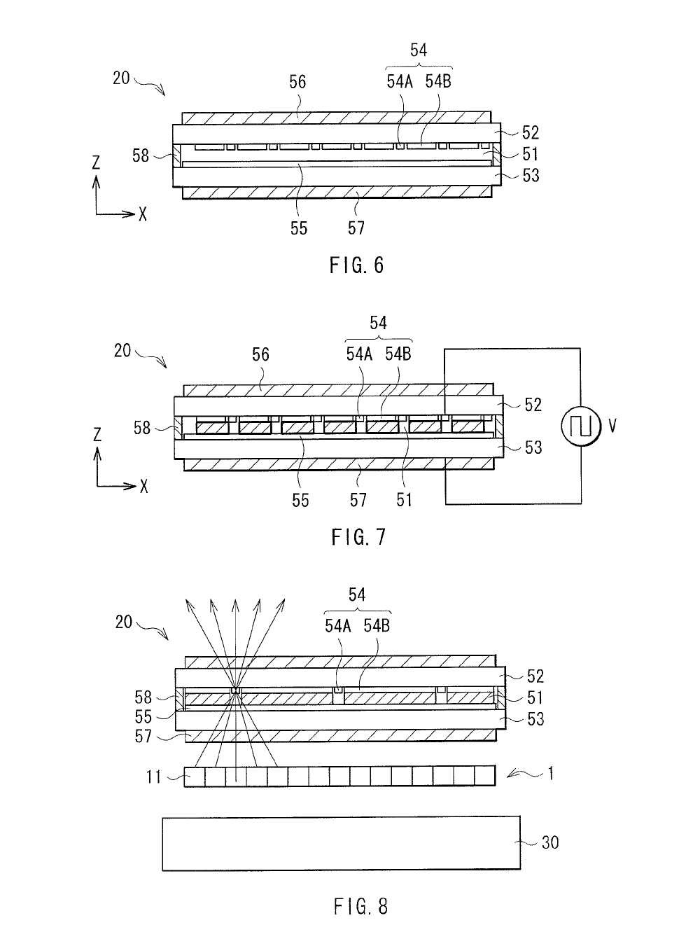

In the present embodiment, description will be given below with an example of a case in which the parallax device 20 is configured of the variable parallax barrier 2A based on a liquid crystal device as shown in FIGS. 4 to 7.

The parallax device 20 includes a liquid crystal material 51, a first transparent parallel plate 52, a second transparent parallel plate 53, a first transparent electrode 54, a second transparent electrode 55, a first polarizer 56, a second polarizer 57, and a sealing agent 58.

The liquid crystal material 51 is enclosed between the first transparent parallel plate 52 and the second transparent parallel plate 53. The first transparent electrode 54 configured of a material such as ITO (Indium Tin Oxide) is provided on a surface on the liquid crystal material 51 side of the first transparent parallel plate 52. Similarly, the second transparent electrode 55 is provided on a surface on the liquid crystal material 51 side of the second transparent parallel plate 53.

The second transparent electrode 55 is a planar electrode. The first transparent electrode 54 has a configuration in which a plurality of first divided electrodes 54A and a plurality of second divided electrodes 54B are alternately arranged in a lateral direction as shown in FIG. 5. The first divided electrodes 54A have positions and shapes corresponding to those of the opening section 21 in the parallax barrier 2A, and may so extend in a vertical direction (Y-direction) to have a first electrode width, for example. The second divided electrodes 54B have positions and shapes corresponding to those of the shielding section 22 in the parallax barrier 2A, and may so extend in the vertical direction as to have a second electrode width, for example.

In the parallax device 20, alignment of the liquid crystal material 51 varies according to a drive voltage V that is applied to the first transparent electrode 54 and to the second transparent electrode 55 as shown in FIG. 7. Light from the display section 1 is transmitted through the first polarizer 56, thereby becoming a linearly-polarized light. The orientation of polarization is controlled by alignment of the liquid crystal material 51 when the light is transmitted through the liquid crystal material 51. Intensity modulation is performed when the light is transmitted through the second polarizer 57. The parallax device 20 may operate, for example, in a so-called normally-black mode in which light is transmitted upon application of the drive voltage V and light is shielded without application of the drive voltage V. Alternatively, the parallax device 20 may operate in a so-called normally-white mode in which light is shielded upon application of the drive voltage V and is transmitted without application of the drive voltage V. Hereinbelow, description will be given of the parallax device 20 that operates in the normally-black mode.

As described above, the first divided electrodes 54A in the first transparent electrode 54 are provided with the positions and the shapes corresponding to the opening section 21. Therefore, by applying the drive voltage V only to the first divided electrodes 54A in the first transparent electrode 54, only a portion corresponding to the first divided electrodes 54A becomes a light transmitting state as shown in FIG. 7 and the parallax function is activated. This achieves three-dimensional display by the parallax barrier scheme. On the other hand, by applying the drive voltage V to both of the first divided electrodes 54A and the second divided electrodes 54B, the entire region becomes a light transmitting state and the parallax function is deactivated. This achieves ordinary two-dimensional display.

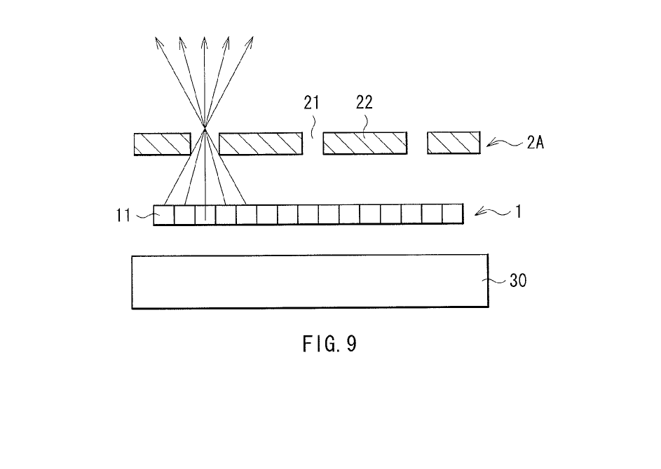

FIG. 8 illustrates an example of a state in which three-dimensional display is performed with the use of the parallax device 20 shown in FIGS. 4 to 7. FIG. 9 illustrates an example of a display unit of a parallax barrier scheme that is optically equivalent to a display unit shown in FIG. 8. FIG. 8 and FIG. 9 illustrate an example in which three-dimensional display with five perspectives is performed as an example.

Upon performing three-dimensional display with five perspectives, as shown in the upper part of FIG. 10, first to fifth perspective images are space-divisionally displayed, as the three-dimensional image, in order in the pixels 11 in the display section 1. The numbers of 1 to 5 attached to the pixels 11 in the upper part of FIG. 10 represent the first to fifth perspective images. Upon performing two-dimensional display, the two-dimensional image is displayed in the pixels 11 in the display section 1.

In this case, the entire region of the parallax device 20 becomes a light transmitting state as shown in the lower part of FIG. 10.

### [Operation Example for Mixed Display of Two-Dimensional Image and Three-Dimensional Image]

Next, description will be given of an operation example of partial three-dimensional display (mixed display of a two-dimensional image and a three-dimensional image).

The control section 44 displays, at certain timing, a three-dimensional image in a first region 61 in a predetermined display region in the display section 1, for example, as shown in a display example 70 in FIG. 12. In this case, portions other than the first region 61 may perform, for example, black display. Also, the control section 44 displays, at another timing, a two-dimensional image in a second region 62 in the predetermined display region in the display section 1, for example, as shown in a display example 71 in FIG. 12. In this case, portions other than the second region 62 may perform, for example, black display. The above-described three-dimensional display and two-dimensional display are time-divisionally performed in a predetermined short time period (for example, in one frame period). This allows a viewer to perceive the two-dimensional image and the three-dimensional image to be displayed in a mixed manner as shown in a display example 72 in FIG. 12.

Parts (A) to (D) of FIG. 11 illustrate an example of operation timing of each section upon performing such mixed display. Part (A) of FIG. 11 illustrates operation timing of the display section 1. Part (B) of FIG. 11 illustrates operation timing (operation timing to activate the parallax function) of a portion (the first divided electrodes 54A, see FIG. 5, etc.) corresponding to the opening section 21 in the parallax device 20. Part (C) of FIG. 11 illustrates operation timing to allow the entire region of the parallax device 20 to become a light transmitting state. Part (D) of FIG. 11 illustrates operation timing of the backlight 30.

In Part (A) of FIG. 11, a vertical axis shows a position in the vertical direction in the screen of the display section 1. The image data Din is line-sequentially written to the display section 1 from an upper portion to a lower portion of the screen. When the display section 1 is a liquid crystal display panel, it takes time for the liquid crystal to actually response from the beginning of writing image data Din. In order to prevent image quality degradation resulting from the delay of response of the liquid crystal, the control section 44 allows the display section to display the same image successively twice for each of the three-dimensional image and the two-dimensional image. In other words, the same three-dimensional image is displayed successively twice in a first half of one frame period with a cycle of 60 Hz, and then, the same two-dimensional image is displayed successively twice in a second half. It is to be noted that a portion indicated in gray in Part (A) of FIG. 11 indicates a state in which an image different from an image which should be displayed is displayed due to the delay of response of the liquid crystal. For example, in a period in which the first writing of the two-dimensional image data is performed, a state in which the three-dimensional image which has been displayed immediately before is displayed is maintained for a certain delay period.

The parallax device 20 activates the parallax function in accordance with the display timing of the three-dimensional image shown in Part (A) of FIG. 11, as shown in Part (B) of FIG. 11. In this case, in order to prevent the above-described image quality degradation resulting from the delay of response of the liquid crystal, the parallax device 20 activates the parallax function at delayed timing that is an end of a predetermined time period that starts from beginning of the first writing of the three-dimensional image data.

Also, the parallax device 20 allows the entire region thereof to become a light transmitting state according to the display timing of the two-dimensional image shown in Part (A) of FIG. 11, as shown in Part (C) of FIG. 11. In this case, in order to prevent the above-described image quality degradation resulting from the delay of response of the liquid crystal, the parallax device 20 allows the entire region thereof to become a light transmitting state at delayed timing that is an end of a predetermined time period that starts from beginning of the first writing of the two-dimensional image data.

The backlight 30 emits light for image display toward the display section 1 in accordance with the display timing of the three-dimensional image and the two-dimensional image as shown in Part (D) of FIG. 11. In this case, in order to prevent the above-described image quality degradation resulting from the delay of response of the liquid crystal, the backlight 30 begins light emission at delayed timing that is an end of a predetermined time period that starts from the beginning of the first writing of the image data showing the three-dimensional image or the two-dimensional image for each of the cases of displaying the three-dimensional image and of displaying the two-dimensional image. It is to be noted that Part (D) of FIG. 11 illustrates an example in which the backlight 30 is divided into four parts, that is, a first partial light emission section 3-1, a second partial light emission section 3-2, a third partial light emission section 3-3, and a fourth partial light emission section 3-4 to control light emission.

### [Effects]

As described above, according to the display unit of the present embodiment, the three-dimensional image and the two-dimensional image are time-divisionally displayed. Also, the three-dimensional image is displayed in the first region 61 and the two-dimensional image is displayed in the second region 62. Therefore, mixed display of the two-dimensional image and the three-dimensional image is achieved. Since the display is performed in a time-divisional manner, degradation in spatial resolution of the two-dimensional image is prevented, in particular.

### 2. Second Embodiment

Next, description will be given of a display unit according to a second embodiment of the present disclosure. It is to be noted that the same numerals are used to designate substantially the same components of the display unit according to the first embodiment, and the description thereof will be appropriately omitted.

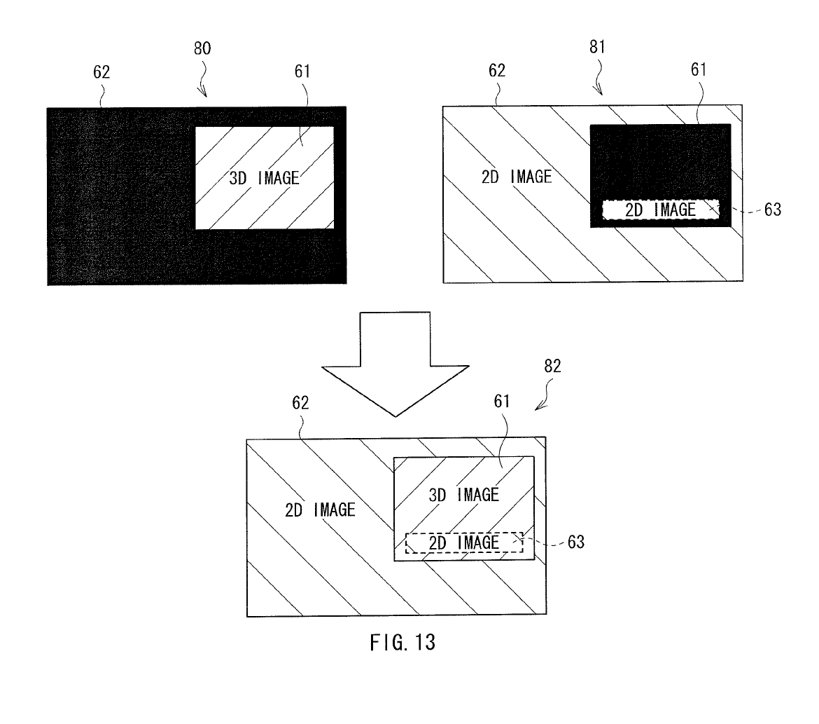

In the above-described first embodiment, an example in which the first region 61 displaying the three-dimensional image is provided separately from the second region 62 displaying the two-dimensional image completely as shown in the display examples 70 to 72 in FIG. 12 has been described. However, parts of the two regions may overlap. For example, display as shown in display examples 80 to 82 in FIG. 13 may be performed instead of the display examples 70 to 72 in FIG. 12. In other words, display may be performed so that another second region 63 displaying a two-dimensional image is partially included in the first region 61 displaying the three-dimensional image as shown in the display examples 80 to 82 in FIG. 13. For example, when a picture content, for example, including subtitles in the first region 61 is displayed, it may be easy to see the content as a picture when the subtitle portion is displayed in a two-dimensional manner. In such a case, the subtitle portion is two-dimensionally displayed in the second region 63 in the first region 61.

### 3. Third Embodiment

Next, description will be given of a display unit according to a third embodiment of the present disclosure. It is to be noted that the same numerals are used to designate substantially the same components of the display unit according to the first or second embodiment, and the description thereof will be appropriately omitted.

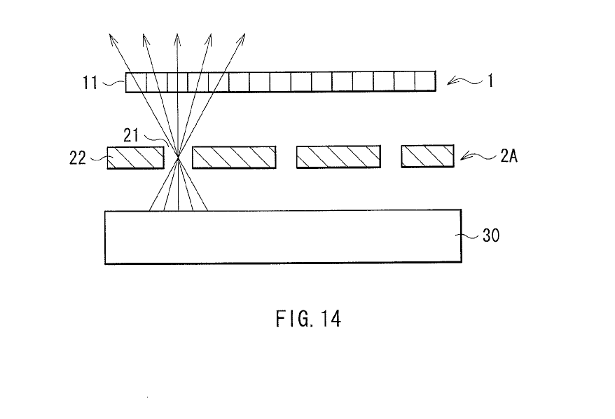

In the above-described first embodiment, the case in which the parallax device 20 is located on a front face side of the display section 1 (between the display section 1 and a viewer) has been described as an example. However, a configuration may be adopted in which the parallax device 20 is located on the back face side of the display section 1 (between the display section 1 and the backlight 30). FIG. 14 illustrates an example of a display unit of a parallax barrier scheme that is optically equivalent to that in a state of performing three-dimensional display in a case of adopting such a configuration.

### 4. Fourth Embodiment

Next, description will be given of a display unit according to a fourth embodiment of the present disclosure. It is to be noted that the same numerals are used to designate substantially the same components of the display units according to the first to third embodiments, and the description thereof will be appropriately omitted.

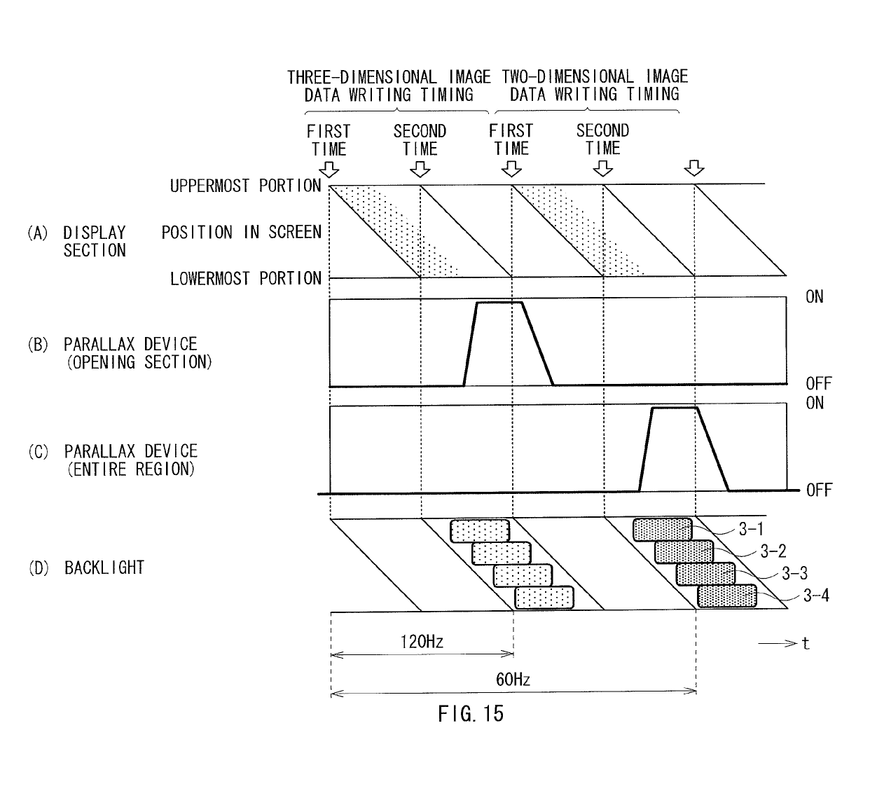

Comparing the case of performing two-dimensional display to the case of performing three-dimensional display in a parallax barrier scheme, luminance in the three-dimensional display is relatively dark (luminance in the two-dimensional display is relatively bright) because of the shielding section 22 included in the parallax device 20 (parallax barrier 2A). In a case of performing mixed display of a two-dimensional image and a three-dimensional image and when the difference in luminance leads to degradation in display quality, for example, the backlight 30 may be controlled to lower light emission luminance in the case of displaying the two-dimensional image with respect to the case of displaying the three-dimensional image. Parts (A) to (D) of FIG. 15 illustrate an example of operation timing of each section upon performing such control. The operation is similar to that in Parts (A) to (D) of FIG. 11, except that the light emission luminance of the backlight 30 is lowered upon performing two-dimensional display in Part (D) of FIG. 15. It is to be noted that, as a method of lowering light emission luminance, when the backlight 30 is configured of a plurality of light emitting elements such as LEDs, for example, a method of lowering a value of the drive current of each light emitting element may be adopted. Alternatively, for example, when the drive current for each light emitting element is controlled by pulse width modulation, a method of decreasing a duty ratio may be adopted.

### 5. Fifth Embodiment

Next, description will be given of a display unit according to a fifth embodiment of the present disclosure. It is to be noted that the same numerals are used to designate substantially the same components of the display units according to the first to fourth embodiments, and the description thereof will be appropriately omitted.

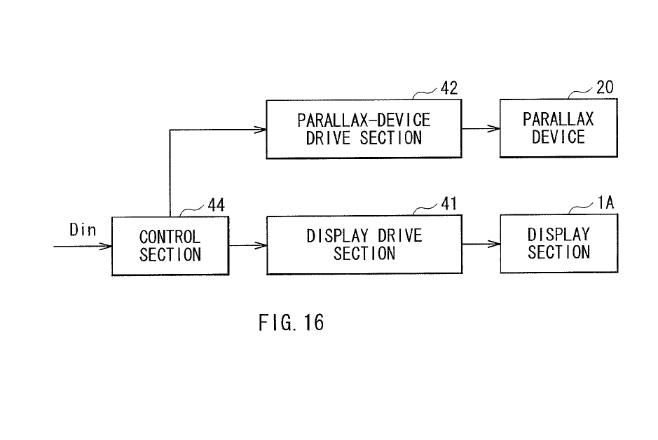

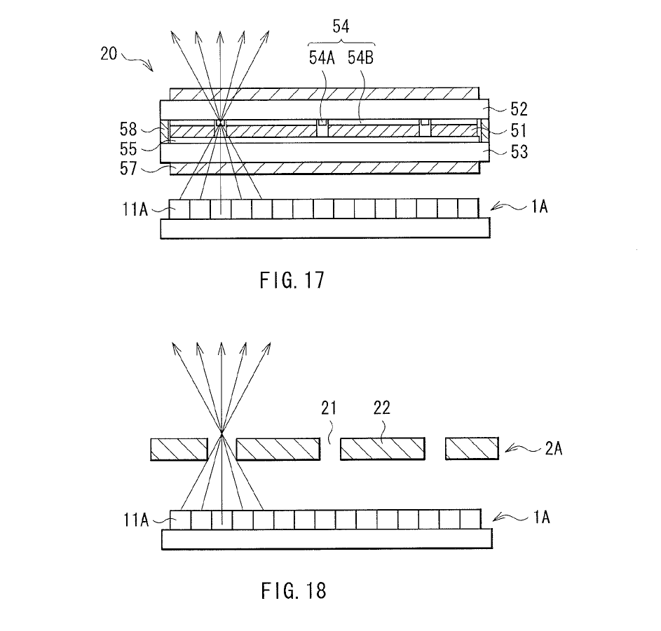

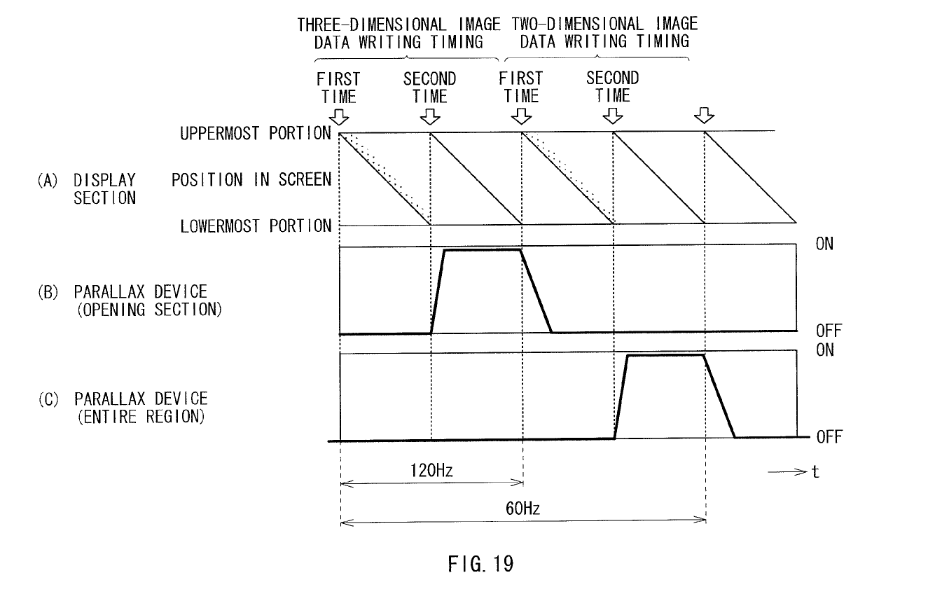

FIG. 16 illustrates a configuration example of a display unit according to the present embodiment. FIG. 17 illustrates an example of a state in which three-dimensional display is performed in the display unit according to the present embodiment. FIG. 18 illustrates an example of a display unit of a parallax barrier scheme that is optically equivalent to the display unit shown in FIG. 17. Parts (A) to (C) of FIG. 19 illustrate operation timing of each section upon performing mixed display of a two-dimensional image and a three-dimensional image.

In the above-described first embodiment, the display unit of a backlight scheme has been described as an example. However, the display unit according to the present embodiment includes a display section 1A that uses a self-emitting element 11A such as an OLED (Organic Light Emitting Diode) and the backlight 30 is removed from the configuration thereof.

The operation timing in Parts (A) to (C) of FIG. 19 corresponds to the operation timing in Parts (A) to (C) of FIG. 11. Parts (A) to (C) of FIG. 11 illustrate the operation timing in consideration of the delay of liquid crystal response due to the fact that the display section 1 is a liquid crystal display panel. However, when the self-emitting element 11A such as an OLED is used, such delay in display operation is small. Therefore, as shown in Part (B) of FIG. 19, a period to keep the parallax function of the parallax device 20 to be activated can be made longer than in the operation timing shown in Part (B) of FIG. 11. This improves luminance upon three-dimensional display. Also, as shown in Part (C) of FIG. 19, a period to keep the entire region of the parallax device 20 to be a light transmitting state can be made longer than in the operation timing shown in Part (C) of FIG. 11. This improves luminance upon two-dimensional display.

### 6. Sixth Embodiment

Next, description will be given of a display unit according to a sixth embodiment of the present disclosure. It is to be noted that the same numerals are used to designate substantially the same components of the display units according to the first to fifth embodiments, and the description thereof will be appropriately omitted.

### [Configuration of Display Unit]

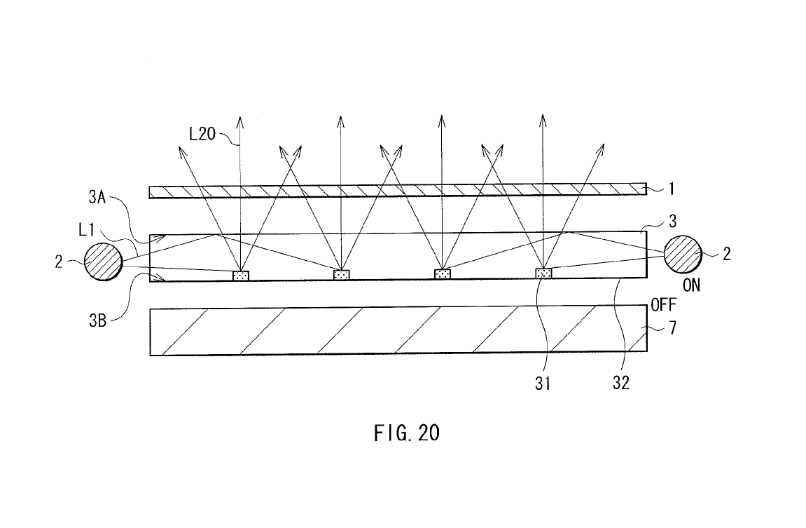

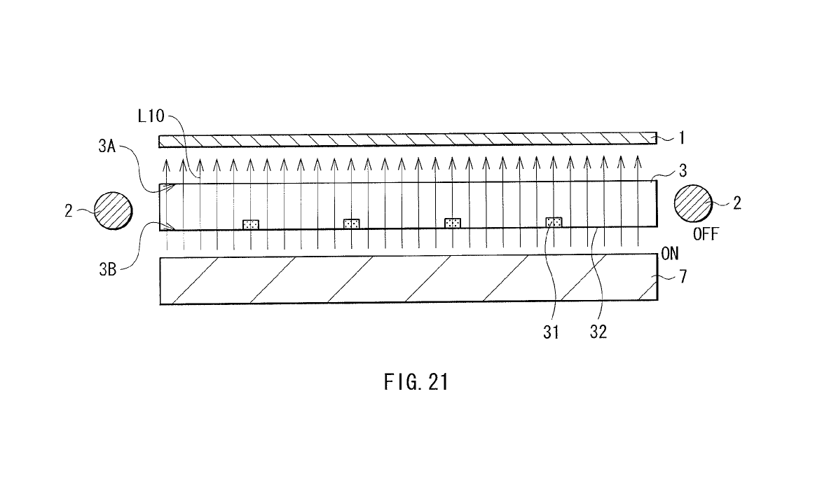

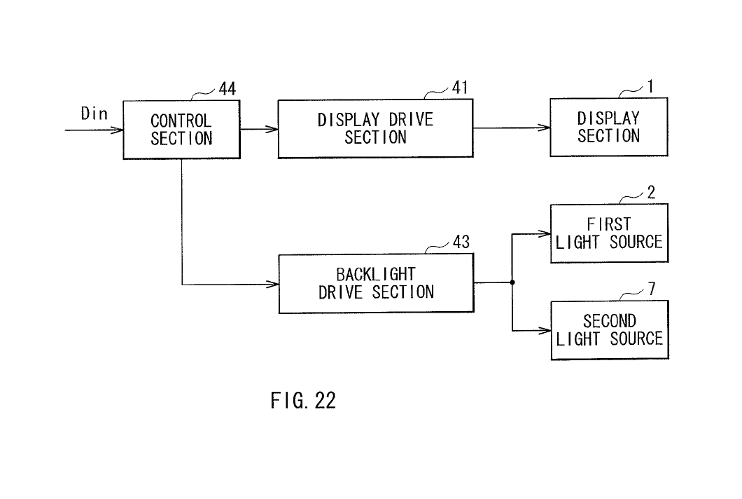

FIG. 20 illustrates a configuration example of the display unit according to the present embodiment together with an emission state of light rays upon performing three-dimensional display. FIG. 21 illustrates a configuration example of the display unit according to the present embodiment together with an emission state of light rays upon two-dimensional display. FIG. 22 illustrates a configuration example of a control system of the display unit according to the present embodiment.

The display unit includes the display section 1 and a light source device that is arranged on the back face side of the display section 1 and emits light for image display toward the display section 1 as shown in FIGS. 20 and 21. The light source device includes a first light source 2, a light guide plate 3, and a second light source 7. The light guide plate 3 includes a first internal reflection surface 3A that faces the display section 1 and a second internal reflection surface 3B that faces the second light source 7. The first light source 2 and the second light source 7 are driven by the backlight drive section 43 based on the control by the control section 44 as shown in FIG. 22. The configuration of the display section 1 is similar to that in the above-described first embodiment.

The display unit is capable of optionally and selectively switching two-dimensional display and three-dimensional display. The switching between two-dimensional display and three-dimensional display is achieved by controlling switching of the image data to be displayed on the display section 1 and by controlling switching of ON and OFF of the first light source 2 and the second light source 7. FIG. 20 schematically illustrates the emission state of light rays from the light source device in a case where only the first light source 2 is turned on (lit), which corresponds to three-dimensional display. FIG. 21 schematically illustrates the emission state of light rays from the light source device in a case where only the second light source 7 is turned on (lit), which corresponds to two-dimensional display.

The first light source 2 may be configured, for example, of a fluorescent lamp such as a CCFL (Cold Cathode Fluorescent Lamp), an LED (Light Emitting Diode), or the like. The first light source 2 applies first illumination light L1 (FIG. 20) toward inside of the light guide plate 3 from a side-face direction. One or more first light sources 2 are arranged on side faces of the light guide plate 3. For example, when the light guide plate 3 has a quadrangular planar shape, there are four side faces. However, it is enough that the first light source 2 is arranged on at least any one of the side faces.

The second light source 7 is arranged on the second internal reflection surface 3B side of the light guide plate 3 to face the light guide plate 3. The second light source 7 applies second illumination light L10 toward the light guide plate 3 from a direction different from that of the first light source 2. More specifically, the second light source 7 applies the second illumination light L10 from the outside (from the back face side of the light guide plate 3) toward the second internal reflection surface 3B (see FIG. 21). It is enough that the second light source 7 is a planar light source that emits light with uniform in-plane luminance and the structure itself is not limited to a specific structure. A commercially-available planar backlight may be used as the second light source 7. For example, a structure such as that using a light emitting body such as a CCFL and an LED and an optical diffusion plate to allow uniform in-plane illumination may be adopted. At least one second light source 7 is provided.

The light guide plate 3 may be configured, for example, of a transparent plastic plate made of a material such as an acrylic resin. All of the surfaces of the light guide plate 3 are transparent as a whole except for the second internal reflection surface 3B. For example, when the light guide plate 3 has a quadrangular planar shape, the first internal reflection surface 3A and four side faces as a whole are transparent.

The first internal reflection surface 3A as a whole is subjected to a mirror process. The first internal reflection surface 3A performs total internal reflection on a light ray that is incident thereon at an incident angle satisfying the total reflection condition inside the light guide plate 3 and emits light rays out of the total reflection condition to the outside.

The second internal reflection surface 3B includes a scattering area 31 and a total reflection area 32. The scattering area 31 may be formed, for example, by performing a laser process, a sandblast process, or a coating process on the surface of the light guide plate 3, or by attaching a sheet-like light scattering member on the surface of the light guide plate 3, or the like. In the second internal reflection surface 3B, the scattering area 31 functions as the opening section 21 in the parallax barrier 2A (see FIG. 14, etc.) with respect to the first illumination light L1 from the first light source 2 upon performing three-dimensional display, and the total reflection area 32 functions as the shielding section 22. In the second internal reflection surface 3B, the scattering area 31 and the total reflection area 32 are provided in a pattern so as to have a structure corresponding to the parallax barrier 2A. In other words, the total reflection areas 32 are provided in a pattern corresponding to the shielding section 22 in the parallax barrier 2A, and the scattering areas 31 are provided in a pattern corresponding to the opening sections 21 in the parallax barrier 2A.

The total reflection area 32 in the first internal reflection surface 3A and in the second internal reflection surface 3B performs total internal reflection on a light ray that is incident thereon at an incident angle θ1 that satisfies the total reflection condition (performs total internal reflection on the light ray that is incident thereon at an incident angle θ1 larger than a predetermined critical angle α). Accordingly, the first illumination light L1 from the first light source 2 that is incident at the incident angle θ1 that satisfies the total reflection condition is guided in a side-face direction by total internal reflection between the first internal reflection surface 3A and the total reflection area 32 in the second internal reflection surface 3B. The total reflection area 32 also transmits the second illumination light L10 from the second light source 7 and emits the second illumination light L10 toward the first internal reflection surface 3A as light rays out of the total reflection condition.

The scattering area 31 scatters and reflects the first illumination light L1 from the first light source 2, and emits part or all of the first illumination light L1 toward the first internal reflection surface 3A as light rays (scattering light rays L20) that are out of the total reflection condition, as illustrated in FIG. 20.

It is to be noted that, in order to spatially separate the plurality of perspective images displayed on the display section 1 in the display unit shown in FIG. 20, it is necessary for a pixel section of the display section 1 to be provided to face the scattering area 31 of the light guide plate 3 while maintaining a predetermined distance in between. In FIG. 20, an air space is provided between the display section 1 and the light guide plate 3 in FIG. 20. However, a spacer may be arranged between the display section 1 and the light guide plate 3 so as to maintain the predetermined distance. In this case, the spacer may be made of any material as long as the material is colorless and transparent and has small scattering properties. For example, PMMA may be used. The spacer may cover whole of the surface on the back face side of the display section 1 and whole of the surface of the light guide plate 3. Alternatively, the spacer may be partially provided in a minimum region necessary to maintain the predetermined distance. Alternatively, a thickness of the light guide plate 3 as a whole may be thickened to eliminate the air space.

### [Basic Display Operation]

In the display unit, upon performing three-dimensional display, image display based on three-dimensional image data is performed in the display section 1, and the first light source 2 and the second light source 7 are controlled to be ON (lit) or OFF (not-lit) for three-dimensional display. Specifically, as shown in FIG. 20, the first light source 2 is controlled to be ON (to be lit) and the second light source 7 is controlled to be OFF (to be not lit). In this state, total internal reflection is repeatedly performed on the first illumination light L1 from the first light source 2 between the first internal reflection surface 3A and the total reflection area 32 in the second internal reflection surface 3B of the light guide plate 3. Accordingly, the first illumination light L1 is guided from one side face on which the first light source 2 is provided to the other side face opposed thereto and emitted from the other side face. On the other hand, part of the first illumination light L1 from the first light source 2 is scattered and reflected in the scattering area 31 in the light guide plate 3, thereby being transmitted through the first internal reflection surface 3A of the light guide plate 3 and being emitted to the outside of the light guide plate 3. Thus, the light guide plate itself achieves a function as the parallax barrier 2A (see FIG. 14, etc.). In other words, with respect to the first illumination light L1 from the first light source 2, the light guide plate 3 functions equivalently as the parallax barrier 2A in which the scattering area 31 serves as the opening section 21 and the total reflection area 32 serves as the shielding section 22. Accordingly, three-dimensional display of a parallax barrier scheme with the parallax barrier 2A arranged on the back face side of the display section 1 is equivalently performed.

On the other hand, upon performing two-dimensional display, image display based on two-dimensional image data is performed in the display section 1, and the first light source 2 and the second light source 7 are controlled to be ON (lit) or OFF (not lit) for two-dimensional display. Specifically, the first light source 2 is controlled to be OFF (to be not lit) and the second light source 7 is controlled to be ON (to be lit), for example, as shown in FIG. 21. In this case, the second illumination light L10 from the second light source 7 transmits through the total reflection area 32 in the second internal reflection surface 3B, thereby being emitted from almost the entire face of the first internal reflection surface 3A to the outside of the light guide plate 3 as light rays out of the total reflection condition. In other words, the light guide plate 3 functions as a planar light source similar to an ordinary backlight. Thus, two-dimensional display of a backlight scheme with an ordinary backlight arranged on the back face side of the display section 1 is equivalently performed.

As described above, the light guide plate 3 functions as a first backlight and the parallax barrier 2A for displaying a three-dimensional image upon incidence of the first illumination light L1. Also, the light guide plate 3 functions as a second backlight for displaying a two-dimensional image upon incidence of the second illumination light L10.

### [Operation Example of Mixed Display of Two-Dimensional Image and Three-Dimensional Image]

Next, description will be given of an operation example upon performing partial three-dimensional display (mixed display of a two-dimensional image and a three-dimensional image) as shown in FIG. 12.

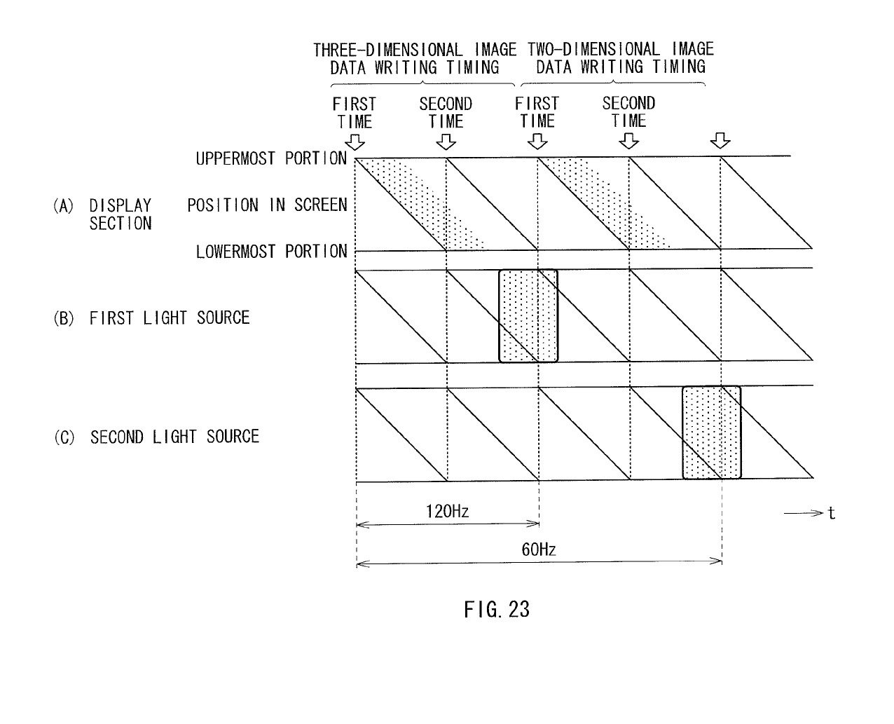

Parts (A) to (C) of FIG. 23 illustrate operation timing of each section upon performing mixed display of a two-dimensional image and a three-dimensional image in the present embodiment. Part (A) of FIG. 23 illustrates operation timing of the display section 1, which is similar to the operation timing shown in Part (A) of FIG. 11.

Part (B) of FIG. 23 illustrates operation timing of the first light source 2. As shown in Part (B) of FIG. 23, the first light source 2 is turned on in accordance with display timing of the three-dimensional image shown in Part (A) of FIG. 23, and thereby, the parallax function of the light guide plate 3 is activated. In this case, in order to prevent the above-described image quality degradation resulting from the delay of response of the liquid crystal, the first light source 2 begins light emission at delayed timing that is an end of a predetermined time period that starts from the beginning of the first writing of the three-dimensional image data.

Part (C) of FIG. 23 illustrates operation timing of the second light source 7. By turning on the second light source 7 in accordance with the display timing of the two-dimensional image in Part (A) of FIG. 23 as shown in Part (C) of FIG. 23, the light guide plate 3 functions as a backlight for displaying the two-dimensional image. In this case, in order to prevent the above-described image quality degradation resulting from the delay of response of the liquid crystal, the second light source 7 begins light emission at delayed timing that is an end of a predetermined time period that starts from the beginning of the first writing of the two-dimensional image data.

### [Effects]

According to the display unit of the present embodiment, mixed display of a two-dimensional image and a three-dimensional display is achieved in a manner similar to that in the above-described first embodiment, in the configuration that uses the light guide plate 3 that functions as the backlight and the parallax barrier 2A.

### 7. Other Embodiments

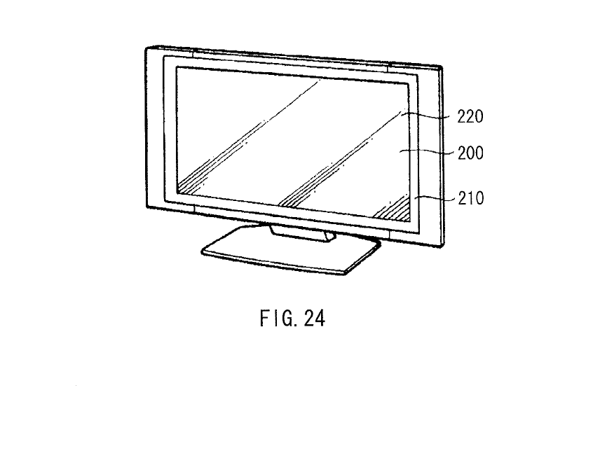

The technology according to the present disclosure is not limited to the description of the above embodiments and may be carried out in various modifications. For example, any of the display units according to the above-described embodiments is applicable to various electronic apparatuses with a display function. FIG. 24 illustrates an appearance configuration of a television as an example of such electronic apparatuses. The television includes an image display screen section 200 that includes a front panel 210 and a filter glass 220.

It is possible to achieve at least the following configurations from the above-described example embodiments and the modifications of the disclosure.

(1) A display unit including:

a display section having a predetermined display region including a first region and a second region; and

a control section allowing the display section to display a three-dimensional image in the first region and allowing the display section to display a two-dimensional image in the second region, the control section allowing the display section to time-divisionally display the three-dimensional image and the two-dimensional image.

(2) The display unit according to (1), further including a variable parallax device having a parallax function that allows a plurality of perspective images, that are included in the three-dimensional image and displayed on the display section, to be separated into different directions, the parallax function of the parallax device being activated at timing of displaying the three-dimensional image.
(3) The display unit according to (2), wherein the parallax function of the parallax device is activated at delayed timing, the delayed timing being an end of a predetermined time period that starts from beginning of writing three-dimensional image data to the display section.
(4) The display unit according to any one of (1) to (3), further including a backlight emitting image-displaying light toward the display section at display timing of the three-dimensional image and at display timing of the two-dimensional image.
(5) The display unit according to (4), wherein

when the three-dimensional image is displayed, the backlight begins light emission at delayed timing, the delayed timing being an end of a predetermined time period that starts from beginning of writing three-dimensional image data to the display section, and

when the two-dimensional image is displayed, the backlight begins light emission at delayed timing, the delayed timing being an end of a predetermined time period that starts from beginning of writing two-dimensional image data to the display section.

(6) The display unit according to (4) or (5), wherein light emission luminance of the backlight for displaying the two-dimensional image is lower than light emission luminance of the backlight for displaying the three-dimensional image.
(7) The display unit according to (2), wherein

the parallax device includes

one or more first light sources each emitting first illumination light at the timing of displaying the three-dimensional image,

one or more second light sources each emitting second illumination light at timing of displaying the two-dimensional image, and

a light guide plate functioning as a first backlight and a parallax barrier that allow the three-dimensional image to be displayed upon incidence of the first illumination light, and functioning as a second backlight that allows the two-dimensional image to be displayed upon incidence of the second illumination light.

(8) The display unit according to (7), wherein

the first light source begins light emission at delayed timing, the delayed timing being an end of a predetermined time period that starts from beginning of writing three-dimensional image data to the display section, and

the second light source begins light emission at delayed timing, the delayed timing being an end of a predetermined time period that starts from beginning of writing two-dimensional image data to the display section.

(9) The display unit according to any one of (1) to (8), wherein a part of the second region is included within the first region.
(10) The display unit according to any one of (1) to (9), wherein the control section allows the display section to time-divisionally display the three-dimensional image and the two-dimensional image in a frame period.
(11) The display unit according to any one of (1) to (10), wherein the control section allows the display section to display the same two-dimensional image for a plurality of times after allowing the display section to display the same three-dimensional image for a plurality of times.
(12) An electronic apparatus provided with a display unit, the display unit including:

a display section having a predetermined display region including a first region and a second region; and

a control section allowing the display section to display a three-dimensional image in the first region and allowing the display section to display a two-dimensional image in the second region, the control section allowing the display section to time-divisionally display the three-dimensional image and the two-dimensional image.

The present application contains subject matter related to that disclosed in Japanese Priority Patent Application JP 2012-105218 filed in the Japan Patent Office on May 2, 2012 the entire content of which is hereby incorporated by reference.

It should be understood by those skilled in the art that various modifications, combinations, sub-combinations, and alterations may occur depending on design requirements and other factors insofar as they are within the scope of the appended claims or the equivalents thereof.

What is claimed is:

1. A display unit comprising:
a display section having a predetermined display region including a first region and a second region; and
a control section allowing the display section to display a three-dimensional image in the first region and allowing the display section to display a two-dimensional image in the second region, the control section allowing the display section to time-divisionally display the three-dimensional image and the two-dimensional image.

2. The display unit according to claim 1, further comprising a variable parallax device having a parallax function that allows a plurality of perspective images, that are included in the three-dimensional image and displayed on the display section, to be separated into different directions, the parallax function of the parallax device being activated at timing of displaying the three-dimensional image.

3. The display unit according to claim 2, wherein the parallax function of the parallax device is activated at delayed timing, the delayed timing being an end of a predetermined time period that starts from beginning of writing three-dimensional image data to the display section.

4. The display unit according to claim 1, further comprising a backlight emitting image-displaying light toward the display section at display timing of the three-dimensional image and at display timing of the two-dimensional image.

5. The display unit according to claim 4, wherein
when the three-dimensional image is displayed, the backlight begins light emission at delayed timing, the delayed timing being an end of a predetermined time period that starts from beginning of writing three-dimensional image data to the display section, and
when the two-dimensional image is displayed, the backlight begins light emission at delayed timing, the delayed timing being an end of a predetermined time period that starts from beginning of writing two-dimensional image data to the display section.

6. The display unit according to claim 4, wherein light emission luminance of the backlight for displaying the two-dimensional image is lower than light emission luminance of the backlight for displaying the three-dimensional image.

7. The display unit according to claim 2, wherein
the parallax device includes
one or more first light sources each emitting first illumination light at the timing of displaying the three-dimensional image,
one or more second light sources each emitting second illumination light at timing of displaying the two-dimensional image, and
a light guide plate functioning as a first backlight and a parallax barrier that allow the three-dimensional image to be displayed upon incidence of the first illumination light, and functioning as a second backlight that allows the two-dimensional image to be displayed upon incidence of the second illumination light.

8. The display unit according to claim 7, wherein
the first light source begins light emission at delayed timing, the delayed timing being an end of a predetermined time period that starts from beginning of writing three-dimensional image data to the display section, and
the second light source begins light emission at delayed timing, the delayed timing being an end of a predetermined time period that starts from beginning of writing two-dimensional image data to the display section.

9. The display unit according to claim 1, wherein a part of the second region is included within the first region.

10. The display unit according to claim 1, wherein the control section allows the display section to time-divisionally display the three-dimensional image and the two-dimensional image in a frame period.

11. The display unit according to claim 1, wherein the control section allows the display section to display the same two-dimensional image for a plurality of times after allowing the display section to display the same three-dimensional image for a plurality of times.

12. An electronic apparatus provided with a display unit, the display unit comprising:
a display section having a predetermined display region including a first region and a second region; and
a control section allowing the display section to display a three-dimensional image in the first region and allowing the display section to display a two-dimensional image in the second region, the control section allowing the display section to time-divisionally display the three-dimensional image and the two-dimensional image.
